(19) United States
(12) Patent Application Publication
(10) Pub. No.: US 2010/0155680 A1
(43) Pub. Date: Jun. 24, 2010

(54) QUICK RISING SUPPORTING DEVICE

(75) Inventor: CHUN-CHIH LIU, Shijr City (TW)

Correspondence Address: MOTECK ELECTRIC CORP., P.O.BOX 108-00403, TAIPEI, 106, omitted

(73) Assignee: MOTECK ELECTRIC CORP., Shijr City (TW)

(21) Appl. No.: 12/339,050

(22) Filed: Dec. 19, 2008

(51) Int. Cl. B66F 3/36

(52) U.S. Cl. 254/100

(57) ABSTRACT

A quick rising supporting device includes a bar having a first threaded portion and a second threaded portion on the two sides respectively with a first connecting block and a second connecting block, and an axial portion on top of a supporting arm and a swing arm forming a Y shape bar are respectively axially connected to the first and second connecting blocks. A sliding block is formed on a side of the first connection block. The translatory shift of the bar on the second connecting block motivates the first connecting block to move in same direction when the bar rotates, the first connecting block is led by the first threaded portion to rotate and move forward to achieve the dual displacement speed of the supporting device. When the closed supporting arm and the swing arm bias and swing to open, only biasing and swinging of the supporting arm and the swing arm is required to open the supporting arm and the swing arm by using a low rotate dynamic strength to rotate the bar, thus the elevation angle between the supporting arm and the swing arm can be quickly opened or closed, and the rising operation can be faster and smoother with less time.

### BACKGROUND OF THE INVENTION

1. Field of the Invention

The present invention relates to a quick rising supporting device; and more particularly to a supporting device comprising a bar with two anti directional threaded portions, namely a first threaded portion and a second threaded portion, respectively on two sides of the bar. The first threaded portion comprises a first connecting block thereon for translatory shifting along with the bar, and the second threaded portion comprises a second connecting block thereon for translatory shifting along the bar. The translatory shift of the bar achieves a dual displacement speed with the first and second connecting block to synchronously motivate a supporting rack and a swing arm to move at an elevational angle. Thus, the supporting device can be operated faster along a shortened translatory path with less time and thereby substantially reduce the number of rotations of the bar for the swinging and biasing effect while working with the supporting rack and the swing arm.

2. Description of Related Art

Nowadays, numerous supporting devices or object rising structures are being applied in our living environment, for example, the supporting device under the camper or the large stage; a plurality of supporting devices support at every corners underneath for positioning the object, thus the object can be stably positioned to secure the things or persons thereon.

Because people from modern society have higher living standard with better living quality, the idea of having a casual trip has become popular. Going camping is one of the ways to enjoy a casual trip by staying overnight in nature for proper relaxation. But there is a safety concern of fixing the tent directly on the ground; therefore making use of the back of a Recreation Vehicle is an alternative that people may think of for more comfort, safety and convenience.

However, the user has to fix a supporting stand A respectively at every corners after positioning the camping car. Referring to FIGS. 7, 8, the conventional supporting stand A comprises an axle A1, a connecting element A2, a supporting rack A3 and a swing arm A4. The axle A1 has a male thread A 11 along the same direction around the axle A1, and a rotatable rod A12 at a distal end. The connecting element A2 is sleeved around the axle A1 and has a through hole A21 to receive screws for fixing under the bottom of the Recreation Vehicle. The supporting rack A3 has a connecting portion A31 at a distal end thereof to connect to the axle A1 and has two protrusions at two ends respectively inlayed into the tracks on the two sides of the connection element A2. The swing arm A4 is connected to the supporting rack A3 at the primal end and connected to the connecting element A2 at the distal end. Thus, the supporting rack A3 and the swing arm A4 are assembled to move along each other.

When the axle A1 rotates, the axle A1 has two stopping elements A13 to restrict the positioning with the connecting element A2 thus keep the axle A1 to rotate with the connecting element A2 as the axle A1 without back or forth movement. When the connecting portion A31 threaded with the axle A1 rotates by the force of the male thread A11 of the axle A1, the motion of the threads is one going forward after another to accordingly motivate the distal end of the supporting rack A3, and the connecting portion A31 further biases with the primal end of the swing arm A4. The distal end of the swing arm A4 is connected to the connecting element A2 to provide an axle a for the supporting rack A3 to move along with the swing arm A4, and the axle a is formed on the connection element A2. When the connecting portion A31 moves on the axle A1 close to the axle a, a elevation angle b between the supporting rack A3 and the swing arm A4 decreases until the supporting rack A3 completely opens to steadily position on the ground.

However, the above conventional supporting stand A has, for example, the following defects.

1. The motion speed of the connecting portion A31 of the supporting rack A3 depends on the number of the rotations of the axle A1 when the axle A1 rotates; the user has to rotate the axle A1 to let the male thread A11 motivate the connecting portion A31 by opening the supporting rack A3 and the swing arm A4, and the connecting portion A31 has to move to the position on the axle A1 near the axle a to completely open the supporting rack A3, and therefore the operation time is too long, and therefore this defect does not meet the economical benefit.

### SUMMARY OF THE INVENTION

An object of the present invention is to provide a supporting device capable of quickly rising via dual displacement speed to save time.

According to an aspect of the present invention, a bar comprises a first threaded portion and a second threaded portion on the two sides thereof respectively with a first connecting block and a second connecting block, and a supporting arm and a swing arm forming a Y shape bar are respectively axially connected to the first and second connecting blocks. A sliding block is formed on a side of the connection portion of the first connecting block, wherein the sliding block slides on the top plate. The translatory shift of the bar on the second connecting block motivates the first connecting block to move in the same direction when the bar rotates, the first connecting block is led by the first threaded portion to rotate and move forward to achieve the dual displacement speed. Thus, when the supporting arm and the swing arm bias to open or close, the supporting arm and the swing arm can open or close only by using a low rotate dynamic strength to rotate the bar, thus the elevation angle between the supporting arm and the swing arm can be quickly opened or closed, and the rising operation can be faster and smoother with less time.

### BRIEF DESCRIPTION OF THE DRAWING

For a more complete understanding of the present invention, reference will now be made to the following detailed description of preferred embodiments taken in conjunction with the following accompanying drawings.

FIG. 1 is an exploded view of a supporting device according to an embodiment of the present invention.

FIG. 2 is an elevational view of an assembly of a supporting device according to an embodiment of the present invention.

FIG. 3 is a cross sectional side view before using the supporting device according to an embodiment of the present invention.

FIG. 4 is a cross sectional side view after using the supporting device according to an embodiment of the present invention.

FIG. 5 is an elevational of a supporting device according to a preferred embodiment of the present invention.

FIG. 6 is a cross sectional side view of a supporting device according to a preferred embodiment of the present invention.

FIG. 7 is an elevational of a conventional supporting device.

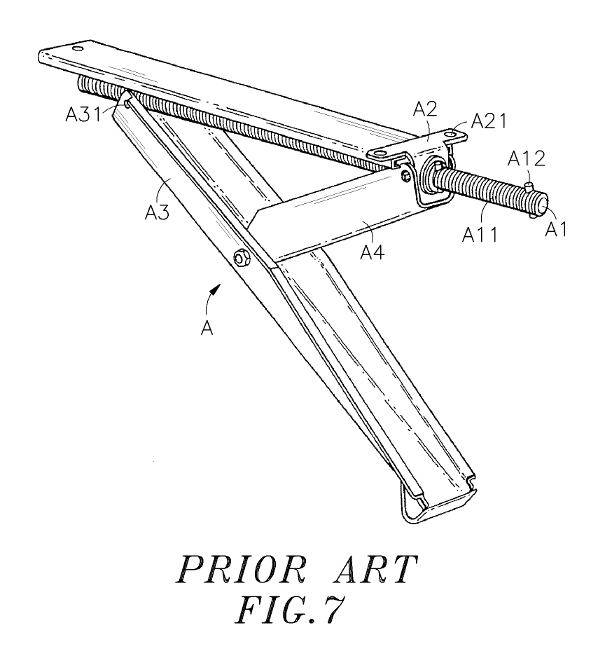

FIG. 8 is a sectional side view of a conventional supporting device.

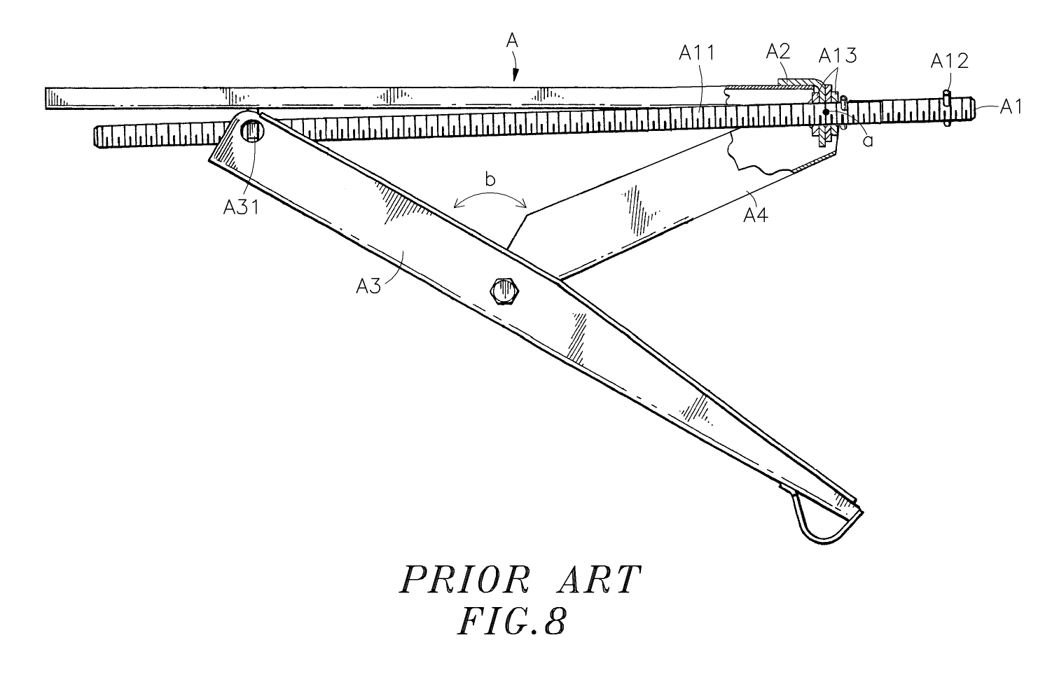

### DETAIL DESCRIPTION OF THE INVENTION

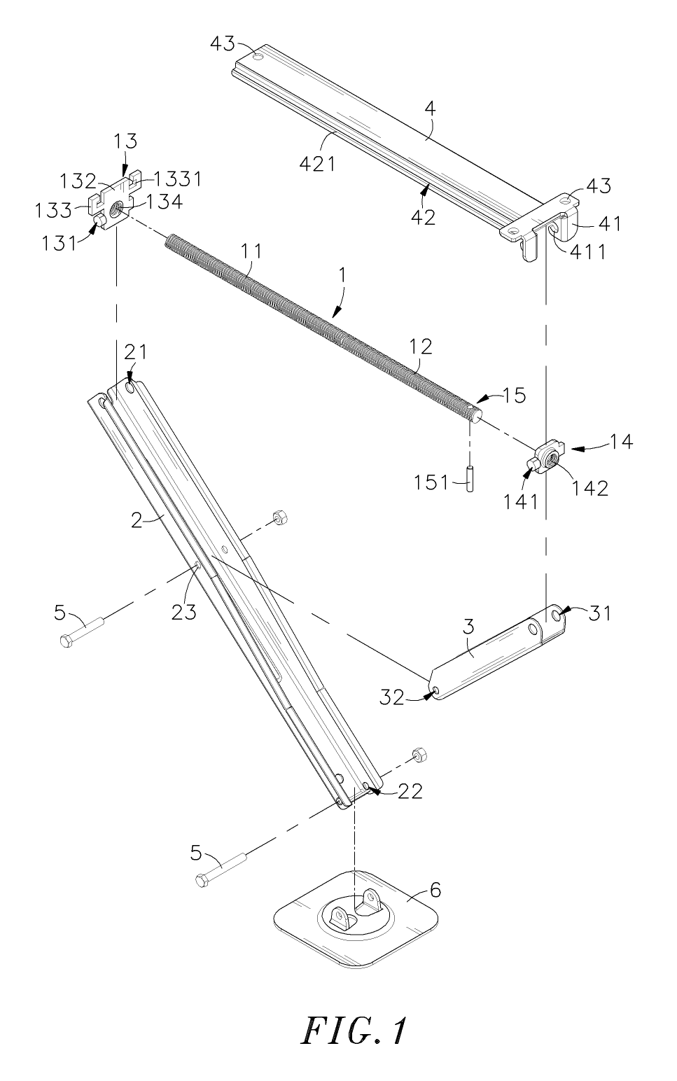

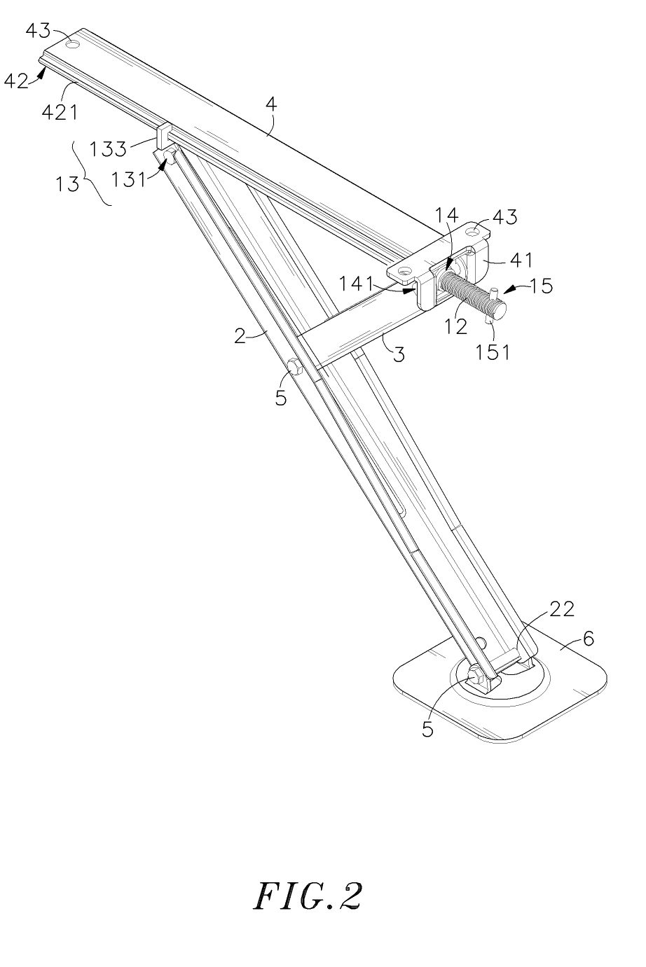

Referring to FIGS. 1 and 2, an exploded view and an elevational view of an assembly of a supporting device according to an embodiment of the present invention, the quick rising supporting device comprises a bar 1, a supporting arm 2, a swing arm 3 and a top plate 4.

A first threaded portion 11 and a second threaded portion 12 are respectively formed on two sides of the bar 1. A threading direction of the first threaded portion 11 is different from that of the second threaded portion 12. The first and second threaded portions 11 and 12 are thread connected to a first connecting block 13 and a second connecting block 14 respectively having threaded holes 134 and 142. The first and second connecting blocks 13 and 14 have connection portions 131 and 141 on the two sides thereof and threaded to the distal ends of the supporting arm 2 and the swing arm 3. The first connecting block 13 comprises a supporting block 132 protruding at a top portion thereof, and a sliding block 133 is bent inwardly to form a track 1331 protruding out above the connection portion 131. The bar 1 comprises a rotation portion 15 at a side thereof.

The supporting arm 2 comprises a connection portion 21 at a distal end for connecting with the connection portion 131 of the first connecting block 13, and a positioning portion 22 at a primal end for supporting on the ground. Through holes 23 are formed between the connection portion 21 and the positioning portion 22 for screwing elements 5 to penetrate there-through.

The swing arm 3 is shorter than the supporting arm 2, and the swing arm 3 comprises a connecting portion 31 for connecting to the connection portion 141 of the second connecting block 14; and a connecting portion 32 is formed at the primal end of the swing arm 3 to connect to the supporting arm 2 by the screwing elements 5 through the through holes 23.

The top plate 4 comprises a positioning plate 41 with axial holes 411 extending downwardly at the two sides thereof. The top plate 4 also comprises a stair-case like sliding track 42 at two corresponding sides continuously bent downward to make the whole top plate into an Ωshape. The distal end of the stair-case like sliding track 42 comprises a protrusion 421 that protrudes outwardly. The positioning plate 41 of the top plate 4 comprises a connecting portion 43 for connecting to an external object, for example, a chassis of car.

The positioning portion 22 of the supporting arm 2 may be axially connected to a supporting plate 6 for supporting against on the ground, or may have apertures on the supporting plate 6 for fixing screwing elements 5 therein to secure on the ground from a top to bottom direction. The screwing elements 5 may be a bolt or a screw.

To assemble the above elements, threaded holes 134 and 142 of the first and second connecting blocks 13 and 14 are correspondingly positioned to the first and second threaded portion 11 and 12 of the bar 1, and the connection portions 131 and 141 of the first and second connecting blocks 13 and 14 are connected to the connection portion 21 and the connecting portion 31 of the supporting arm 2 and the swing arm 3. Next, the connecting portion 32 of the primal end of the swing arm 3 is secured into the through holes 23 of the supporting arm 2 to form a Y shape structure by the supporting arm 2 and the swing arm 3, and thereby position the first connecting block 13 corresponding to the top plate 4 to enable the supporting block 132 of the first connecting block 13 to support against the bottom surface of the top plate 4, and the sliding block 133 of the first connecting block 13 correspondingly position to the two sides of the top plate 4 to restrict the protrusion 421 in the track 1331 of the sliding block 133. Meanwhile, the second connecting block 14 is secured to the swing arm 3 through the connection portion 141 in the axial hole 411 of the positioning plate 41 on the top plate 4 to complete the structure of the supporting device of the present invention.

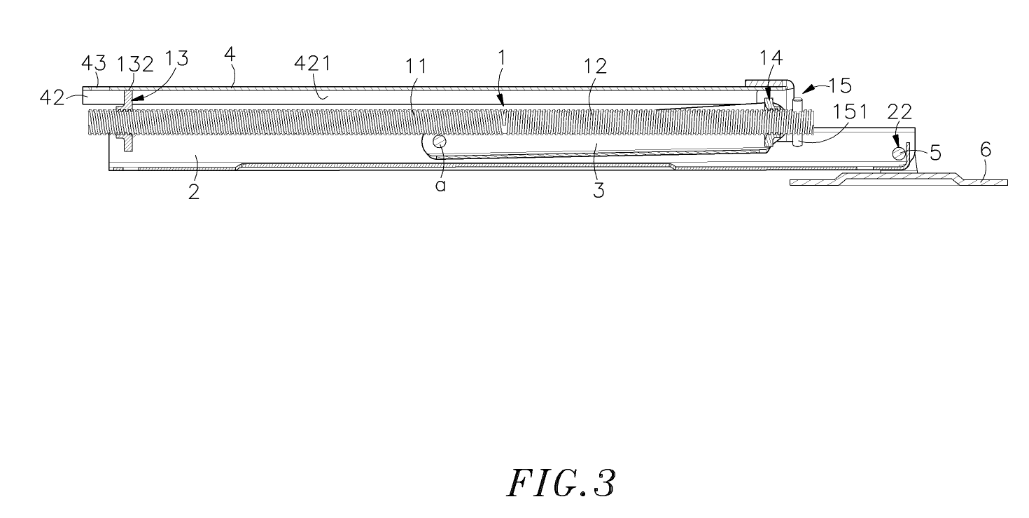

Referring to FIGS. 3, 4 and 5, the cross sectional side views before and after using the supporting device and an elevational of a supporting device according to a preferred embodiment of the present invention, to use the supporting device, the top plate 4 is positioned to the bottom of the external object, and the connecting position 43 is screwed into the external object, for example, a chassis of a car, and then the bar 1 is rotated to open the supporting arm 2 and the swing arm 3. When rotating the rotation portion 15 of the bar 1, the rotation of the bar 1 can synchronously motivate the rotation of the first and the second threaded portions 11 and 12, the first and the second connecting blocks 13 and 14 of the first and second threaded portions 11 and 12 to move towards each other in a translatory shifting manner. Because the second connecting block 14 of the second threaded portion 12 is secured on the positioning plate 41 of the top plate 4, the rotation enables the second threaded portion 12 of the bar 1 to translatory shift in the threaded hole 142 of the second connecting block 14 to accordingly motivate the second connecting block 14 to move along the bar 1. When the bar 1 is continuously rotated, the second connecting block 14 is positioned closer to the central region of the bar 1. The rotation of the second threaded portion 12 of the bar 1 to translatory shift in the threaded hole 142 of the second connecting block 14, the first threaded portion 11 synchronously rotates in a translatory shifting manner to further motivate the first connecting block 13 for translatory shifting. Accordingly, the first connecting block 13 moves towards the second connecting block 14. When the first threaded portion 11 continues to rotate, the first threaded portion 11 can rotate within the threaded hole 134 of the first connecting block 13 to enable the first connecting block 13 to translatory shift accordingly. Thus, the first and second connecting blocks 13 and 14 can achieve a dual displacement speed and move towards each other on the bar 1.

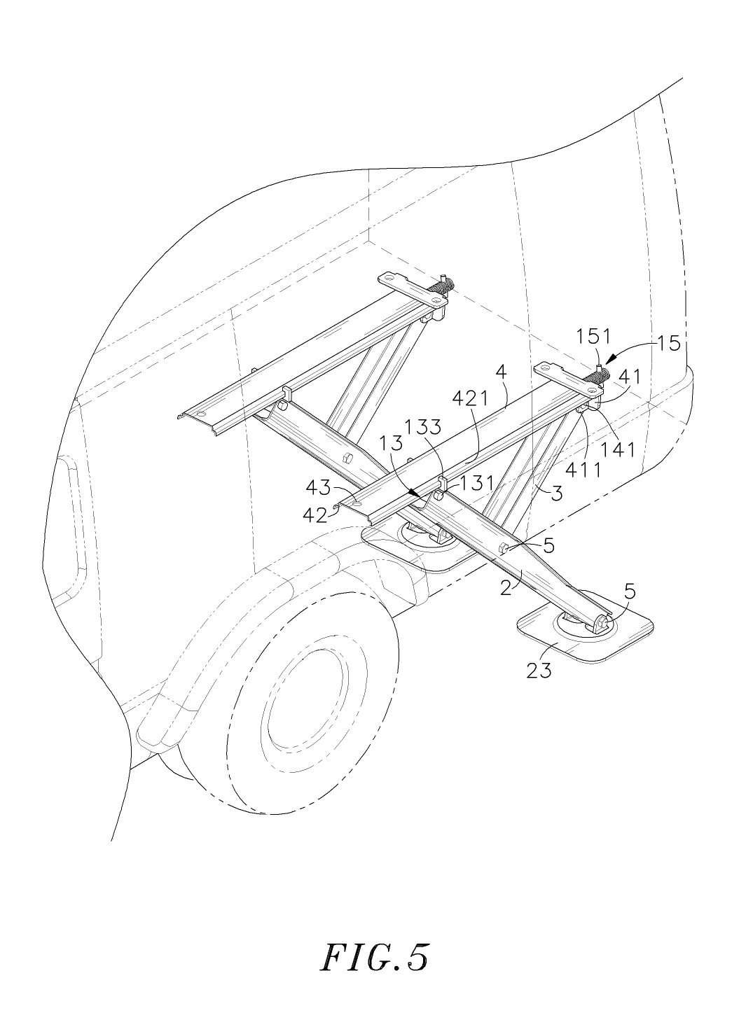

Furthermore, when the bar 1 rotates, the translatory shift of the bar 1 shifts the second connecting block 14 out of the threaded hole 142 to position the second connecting block 14 closer to the center of the bar 1 from the right side, and the first connecting block 13 will also move closer to the center of the bar 1 from the left side, to further enable the first and second threaded portions 11 and 12 to motivate the connection portion 21 and the connecting portion 31 of the supporting arm 2 and the swing arm 3 to move. Thus, a elevation angle b between the supporting arm 2 and the swing arm 3 may be changed with an axle a, the axial conjunction of the supporting arm 2 and the swing arm 3, to complete opening of the supporting arm 2 and the swing arm 3 and the positioning portion 22 of the supporting arm 2 steadily on the ground (as illustrated in FIG. 5) for applying the embodiment of the present invention.

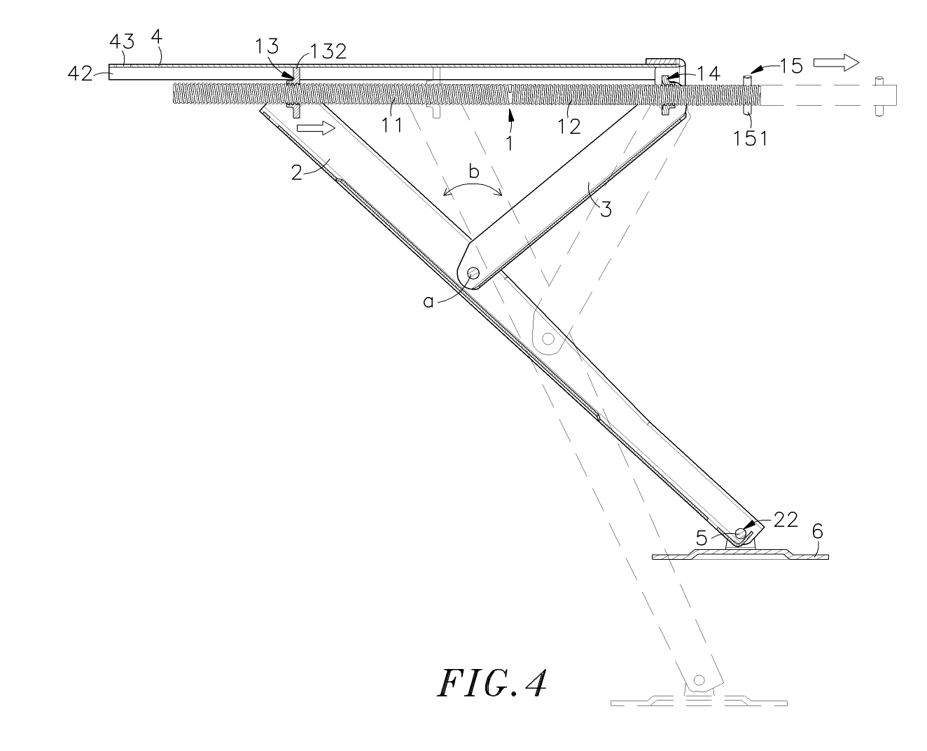

Referring to FIG. 4, from the above operation, it can be learnt that the structure of the supporting device in the present invention comprises two features, one is the axle a is formed at the axial conjunction of the supporting arm 2 and the swing arm 3, because the bar 1 motivates the first connecting block 13 to further motivate the supporting arm 2 and the swing arm 3, and the first connecting block 13 performs a synchronous translatory shift with the bar 1. Accordingly, the connection portion 21 and the connecting portion 31 at the distal end of the supporting arm 2 and the swing arm 3 moves along therewith. When the distal end of the supporting arm 2 and the swing arm 3 moves, the supporting arm 2 and the swing arm 3 moves with the axial conjunction thereof as the axis. In other words, the connection position of the through hole 23 of the supporting arm 2 and the connecting portion 32 of the swing arm 3, for changing the elevation angle b, the axle a at the axial conjunction is formed between the supporting arm 2 and the swing arm 3. When the supporting arm 2 and the swing arm 3 open or close in the elevation angle b along the axle a, the translatory shift can also take place to help movement the first and second threaded portions 11 and 12 of the first and second connecting blocks 13 and 14 towards each other or apart from each other.

The other feature is that the bar 1 rotates and moves in a translatory shifting manner. When the bar 1 rotates, the first and second threaded portions 11 and 12 can be motivated to rotate; when the second threaded portion 12 rotates, the second threaded portion 12 rotates along with the threaded hole 142 of the second connecting block 14 and translatory shift out of the threaded hole 142 to enable the second connecting block 14 to position towards the center of the bar 1. The first threaded portion 11 is motivated by the translatory shift along with the bar 1, the first threaded portion 11 synchronously rotates along with the bar 1 to directly motivate the first connecting block 13 for translatory shift; the thread of the first threaded portion 11 rotates within the thread hole 134 of the first connecting block 13, and the threaded hole 134 of the first connecting block 13 is motivated by the rotation of the first threaded portion 11 for translatory shift, and thereby achieve the dual displacement speed. This structure provides to directly rotate the bar 1 to enable quick movement of the first and second connecting blocks 13 and 14 for opening the supporting arm 2 and the swing arm 3 with a low rotation dynamic strength; when the bar 1 rotates or moves forward, the first and second threaded portions 11 and 12 are threaded to the threaded holes 134 and 142 of the first and second connecting blocks 13 and 14, thus to enable directly rotation of the corresponding threaded surface for smoother and easier operation with less resistance, interference points and low torsion, as well as to substantially save the time and strength for the user.

The rotation portion 15 can be an axial rod 151 fitted through a side of the bar 1 (as shown in FIG. 1), to enable motivation the bar 1 by directly and manually rotating the axial rod 151 to further motivate the supporting arm 2 and the swing arm 3.

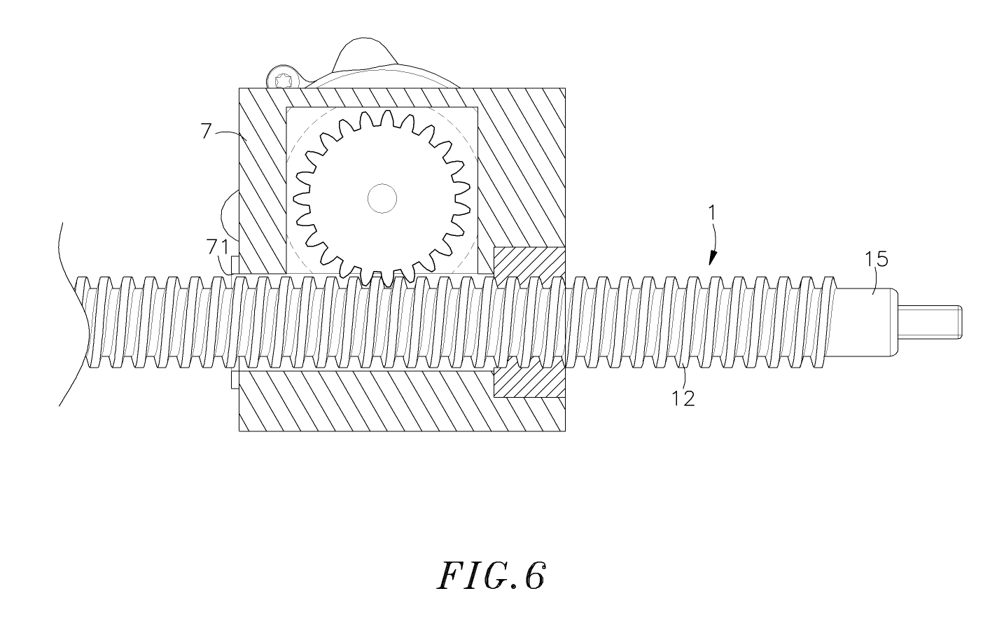

Referring to FIG. 6, a cross sectional side view of a supporting device according to a preferred embodiment of the present invention, the bar 1 may be further connected to an external motor device 7, for example a motor. The bar 1 is penetrating through the connecting groove 71 of the external motor device 7, and the second threaded portion 12 of the bar 1 is engaged to the gear of the connecting groove 71 driven by the external motor device 7. Thus the motor device 7 can motivate the bar 1 to move. Any structural modification to achieve the same effect shall be construed to be within the scope of the present invention.

According to the above depiction, the supporting device of the embodiment of the present invention may be applied at the bottom of the vehicle for a steady support, however, the present invention is not restricted to the supporting device under a vehicle with the quick rising effect, the embodiment of the present invention may also be applied to support any flat top for the steady support.

The bar 1 comprises two anti directional threaded portions, the first threaded portion 11 and the second threaded portion 12, respectively on the two sides thereof, and the first threaded portion 11 may be along the clock direction and the second threaded portion 12 may be in the anti clock direction, or the first threaded portion 11 may be in the anti clock direction and the second threaded portion 12 may be in the clock direction. Any structural modification to achieve the same effect shall be construed to be within the scope of the present invention. Likewise, the above threaded holes 134 and 142 of the first and second connecting blocks 13 and 14 thread connected to the first and second threaded portions 11 and 12 only have be designed to correspond to the above directions of the male and female threads.

The quick rising supporting device of the present invention has at least the following advantages.

1. When rotating portion 15 of the bar 1 rotates, the second threaded portion 12 rotates in the threaded hole 142 of the second connecting block 14 to move forward, and the first threaded portion 11 synchronously motivates the first connecting block 13 to move forward; the forward movement enables the first connecting block 13 to move forward quickly along the stair-case like sliding track 42 of the top plate 4, and thereby open the supporting arm 2 and the swing arm 3 at the elevation angle b with a smooth dual displacement speed operation with less time.

2. When the bar 1 rotates, the axle a of the supporting arm 2 and the swing arm 3 is formed at the axial conjunction thereof, and the connection portion 21 and the connecting portion 31 of the supporting arm 2 and the swing arm 3 move close to each other on the bar 1 to quickly change the elevation angle b.

3. when the supporting arm 2 and the swing arm 3 are closed, because the rotation of the first and second threaded portions 11 and 12 of the bar 1, the first and the second threaded holes 134 and 142 of the first and second connecting blocks 13 and 14 correspondingly rotate to motivate the connection portion 21 and the connecting portion 31 of the supporting arm 2 and swing arm 3 by the bar 1 to translatory shift, and thereby open the supporting arm 2 and the swing arm 3 with a low rotation dynamic strength smoothly with less resistance and interference point, as well as to move faster.

4. The first and second threaded portions 11 and 12 of the bar 1 are connected to the first and second connecting blocks 13 and 14, when the bar 1 rotates, the first and second connecting blocks 13 and 14 move in a shorter distance with the fast operation, and takes less time and the number of the rotation of bar 1 can be substantially reduced to operate the supporting arm 2 and the swing arm 3.

5. The top plate 4 comprises the stair-case like sliding track 42 at the two corresponding sides continuously bent downwards to make the whole top plate 4 into a Ωshape. The protrusion 421 protrudes from a distal end of the stair-case like sliding track 42. The sliding block 133 of the first connecting block 13 positions correspond to the two sides of the top plate 4 to restrict the protrusion 421 in the track 1331 of the sliding block 133. The assembly of the stair-case like sliding track 42 and the protrusion 421 simply requires hooking up the supporting arm 2 to prevent from falling, and it is easy to manufacture with lower weight and cost.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A quick rising supporting device, comprising:
a bar, comprising a first threaded portion threaded with a first connecting block translatory shifting along said bar, and a second threaded portion threaded with a second connecting block translatory shifting along said bar on two sides thereof; wherein said first and second connecting blocks comprise connecting portion respectively on two sides thereof; said first connecting block comprises a supporting block protruded on a top thereof, and a sliding block inwardly bent forming a track protruding outwardly above said connecting portion;
a supporting arm, comprising a connecting portion axially connecting to said first connecting block, and a positioning portion at a primal end supporting against a ground;
a swing arm, comprising a connecting portion axially connecting to said first connecting block, and a positioning portion at a primal end axially connecting with said supporting arm to correspondingly motivate together; and
a top plate, comprising a positioning plate securely connected to said second connecting block, and two sides of said top plate continuously bent downwards into a stair-case like sliding track having a protrusion protruding out at a distal end for restricting positions in said stair-case like sliding track.

2. The quick rising supporting device according to claim 1, wherein a threading of said first and second threaded portions of said bar are formed at opposite directions, and wherein when threading of said first threaded portion is along a clock direction, threading of said second threaded portion is along an anti clock direction.

3. The quick rising supporting device according to claim 1, wherein threading of said first and second threaded portions of said bar are formed at opposite directions, and wherein when threading of said first threaded portion is along an anti clock direction, threading of said second threaded portion is along a clock direction.

4. The quick rising supporting device according to claim 1, wherein said bar comprises a rotating portion on a side for allowing an axial rod to manually rotate said bar.

5. The quick rising supporting device according to claim 1, wherein said first connecting block comprises a threaded hole over a translatory shift on said first threaded portion of said bar.

6. The quick rising supporting device according to claim 1, wherein said second connecting block comprises a threaded hole over a translatory shift on said second thread portion of said bar.

7. The quick rising supporting device according to claim 1, wherein said swing arm is shorter than said supporting arm, and connected at a position to form a Y shape.

8. The quick rising supporting device according to claim 1, wherein said positioning plate of said top plate extends downwards from two sides thereof and comprises an axial hole for securing said connecting portion of said second connecting block; said top plate comprises a connecting portion for connecting to an external object, and two corresponding sides are bent continuously in a downward direction to make said top plate into an Ωshape.
